(19) United States
(12) Patent Application Publication
(10) Pub. No.: US 2020/0134655 A1
(43) Pub. Date: Apr. 30, 2020

(54) REGISTRATION APPARATUS

(71) Applicant: TOSHIBA TEC KABUSHIKI KAISHA, Tokyo (JP)

(72) Inventor: Hisashi MATSUO, Mishima Shizuoka (JP)

(21) Appl. No.: 16/580,447

(22) Filed: Sep. 24, 2019

(30) Foreign Application Priority Data
Oct. 26, 2018 (JP) 2018-202167

(51) Int. Cl. G06Q 30/02; G06K 7/14

(52) U.S. Cl. CPC G06Q 30/0226; G06K 7/1417; G06K 7/1413

(57) ABSTRACT

A mobile registration apparatus includes a code reader, a display, and a processor. The code reader is configured to read a customer identification code symbol to obtain a customer identifier and read a commodity identification code symbol to obtain a commodity identifier. The processor is configured to obtain an accumulated reward points value stored in association with the customer identifier, perform registration of the commodity corresponding to the commodity identifier, calculate estimated reward points based on a total sales price of currently registered commodities, and control the display to display the accumulated reward points value and the estimated reward points.

### CROSS-REFERENCE TO RELATED APPLICATION

This application is based upon and claims the benefit of priority from Japanese Patent Application No. 2018-202167, filed on Oct. 26, 2018, the entire contents of which are incorporated herein by reference.

### FIELD

Embodiments described herein relate generally to a registration apparatus.

### BACKGROUND

In retail stores, such as a supermarket, a loyalty points program has been introduced as a sales promotion method. In such a program, points are granted to a customer based on a purchased amount of a commodity, sales total, or the like, and accumulated reward points can be used as a basis for a price discount on a commodity or exchanged for a commodity. In this way, the customer can benefit from the points program, and, from the viewpoint of the retail store, the number of customers who come to the retail store may increase or frequency of customer visits may increase. Thus, the retail store can increase sales.

In the retail store, a total amount (purchased amount) is typically calculated at the time of checkout, and the value of reward points earned by the customer is also calculated at the time of checkout. Therefore, the customer may not be able to confirm before checkout the value of reward points to be earned according to the commodities being purchased. To address this issue, there is a shopping basket that functions to read a price from any commodity put in the shopping basket and then display the value of reward points to be granted according to the current sales total amount of items placed in the shopping basket.

It is desirable to further improve customer convenience in dealing with the reward points before checkout.

### DESCRIPTION OF THE DRAWINGS

FIG. 1 is a diagram illustrating an external appearance of a cart terminal according to an embodiment.

FIG. 2 is a diagram illustrating a hardware structure of a cart terminal.

FIG. 3 is a diagram illustrating functional aspects of a cart terminal.

FIG. 4 is a diagram illustrating a screen displayed under a control of a display control section.

FIG. 5 is a diagram illustrating a screen displayed under a control of the display control section.

FIG. 6 is a diagram illustrating a screen displayed under a control of the display control section;

FIG. 7 is a diagram illustrating a screen displayed under a control of the display control section.

FIG. 8 is a flowchart illustrating commodity registration processing performed by a cart terminal.

### DETAILED DESCRIPTION

According to an embodiment, a mobile registration apparatus includes a code reader, a display, and a processor. The code reader is configured to read a customer identification code symbol to obtain a customer identifier and read a commodity identification code symbol to obtain a commodity identifier. The processor is configured to obtain an accumulated reward points value stored in association with the customer identifier, perform registration of the commodity corresponding to the commodity identifier, calculate estimated reward points to be earned based on a total sales price of the currently registered commodities, and control the display to display the accumulated reward points value and the estimated reward points.

Example embodiments of a registration apparatus are described with reference to the accompanying drawings. In the following example embodiments, a cart terminal that has been mounted on a shopping cart is described as an example of the registration apparatus, but the present disclosure is not limited to this example embodiment.

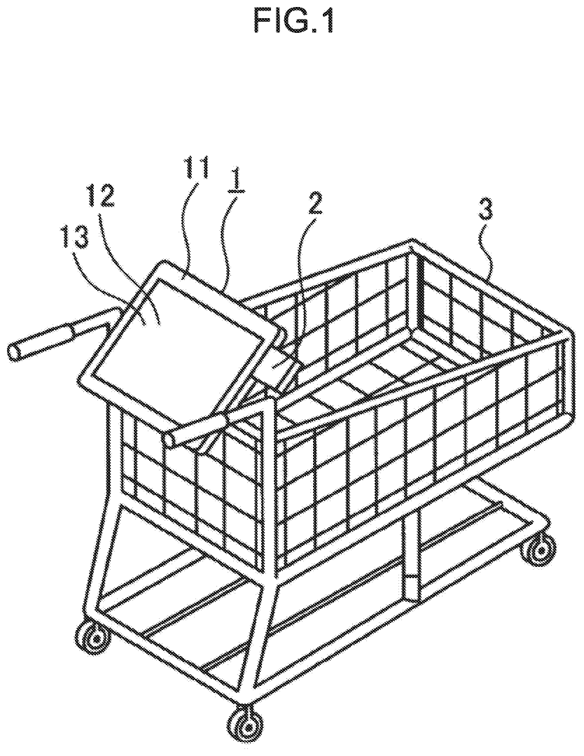

FIG. 1 is a diagram illustrating an external appearance of a cart terminal 1 according to the present embodiment. The cart terminal 1 is mounted on a cart 3 in a retail store to carry commodity to be purchased. Cart 3 may be referred to as a shopping cart 3 in some instances.

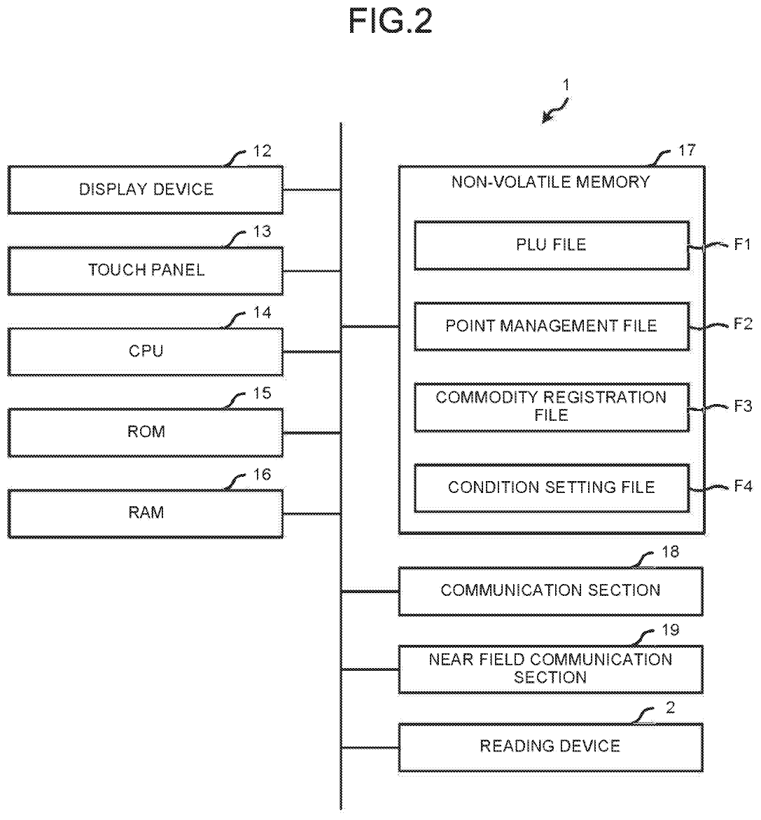

The cart terminal 1 is an information processing apparatus such as a tablet terminal, for example, and includes a display device having a touch panel (refer to FIG. 2). A detachable reading device 2 is connected to a main body 11 of the cart terminal 1.

The reading device 2 is an example of an input/reading module. The reading device 2 scans a code symbol such as a barcode or a two-dimensional code. The reading device 2 reads commodity identification information of a commodity from the code symbol attached to the commodity. For example, the reading device 2 scans the code symbol attached to the commodity, acquires a commodity code included in the code symbol, and outputs the acquired commodity code to the cart terminal 1. The commodity code is an example of second identification information, and each category or type of commodity can be assigned with a unique identifier.

The reading device 2 also reads customer identification information of a customer from a code symbol displayed on a medium carried by the customer. Specifically, the reading device 2 scans a code symbol displayed on a card medium such as a membership card carried by a customer, or reads a code symbol displayed on a screen of a smartphone carried by a customer, to output a member code included in the code symbol to the cart terminal 1. The member code is an example of first identification information, and is assigned with a unique identifier to each customer who carries out a predetermined procedure such as membership registration. Hereinafter, the medium such as a membership card or a smartphone relating to input of the member code is referred to as a customer medium.

The customer who uses the cart terminal 1 operates the reading device 2 to read the customer medium carried by the customer. Thus, the cart terminal 1 specifies or identifies the customer who uses the cart terminal 1 based on the member code input through the reading device 2. The customer puts a commodity in a shopping cart 3 after reading a code symbol attached to the commodity with the reading device 2. Then, the cart terminal 1 specifies the commodity taken by the customer based on the commodity code indicated with the code symbol input through the reading device 2. The shopping cart 3 may include a scale for measuring a total weight of commodities carried with the shopping cart 3. Then, the cart terminal 1 receiving an output from the scale may determine whether the total weight is increased by a value corresponding to the weight of the commodity read by the reading device 2.

FIG. 2 is a diagram illustrating a hardware structure of the cart terminal 1. The cart terminal 1 includes a display device 12, a touch panel 13, a CPU (Central Processing Unit) 14, a ROM (Read Only Memory) 15, a RAM (Random Access Memory) 16, a non-volatile memory 17, a communication section 18 and a near field communication section 19 in addition to the reading device 2 described above.

The display device 12 is an example of a display section. The display device 12 is, for example, an LCD (Liquid Crystal Display). The touch panel 13 is an example of an operation section, and receives an operation (touch operation) on information displayed on the display device 12.

The CPU 14 collectively controls respective sections of the cart terminal 1 by executing programs stored in the ROM 15 or the non-volatile memory 17. The ROM 15 stores programs to be executed by the CPU 14. The RAM 16 is used by the CPU 14 as a work area for temporarily storing values necessary for execution of programs.

The non-volatile memory 17 is, for example, an HDD (Hard Disk Drive) or a flash memory that holds stored information even when a power supply thereof is turned off, and stores various programs and various kinds of setting information. The non-volatile memory 17 stores a PLU file F1, a point management file F2, a commodity registration file F3 and a condition setting file F4.

The PLU file F1 provides commodity information in which the commodity code assigned to each commodity is associated with information relating to the commodity. The commodity information includes an item name, a price (unit price), a category, etc. of the commodity. In this example, the commodity information also includes area information indicating an area in the retail store from which the commodity is sold. The area information is represented by, for example, a shelf number for a display shelf on which the commodity is displayed, position coordinates indicating a display position in the retail store, or the like.

The point management file F2 stores point information in which a member code assigned to each customer (program member) is associated with information relating to the points granted to the customer. The point information includes an accumulated value (value of accumulated points) of points granted to the customer specified by the member code. The points are granted in accordance with a purchased amount (total amount) of the commodities purchased by the customer, and can be used for discounts or exchanged for a commodity. In other words, in the retail store of the present embodiment, a loyalty points service is provided to the customer.

The commodity registration file F3 stores a commodity code read by the reading device 2. In the present embodiment, a processing of storing the commodity code read by the reading device 2 in the commodity registration file F3 corresponds to a processing of registering the commodity.

The condition setting file F4 stores a granting condition (also referred to as a special granting condition) relating to granting of special points in association with the value of points (the value of special points) to be granted when the special granting condition is satisfied. A special point is granted when the special granting condition is satisfied, and this may be calculated separately from the points (regular points) granted in accordance with the purchased amount (total amount) of the commodity. In the present embodiment, a threshold value (threshold amount) relating to the purchased amount of goods is set as the special granting condition. In the present embodiment, satisfaction of the special granting condition means that the purchased amount of goods reaches the threshold amount set in the special granting condition. The threshold amount is an example of a reference amount.

The number of special granting conditions that can be set in the condition setting file F4 is not particularly limited. For example, a plurality of special granting conditions may be set stepwise in such a manner that the threshold amounts increase step by step. In this case, the value of special points associated with respective special granting conditions is preferable set in such a manner that a larger number of points is granted as the threshold amount increases.

The communication section 18 is a network interface such as a wireless LAN (Local Area Network) adapter, for example. The communication section 18 is connected to an in-store network to control communication with an external device (e.g., a store server) connected to the network.

The near field communication section 19 is, for example, a network interface for near field wireless communication conforming to a communication standard such as Bluetooth® Low Energy. The near field communication section 19 controls communication with a near field wireless communication device (a beacon terminal in the following description) installed in a retail store.

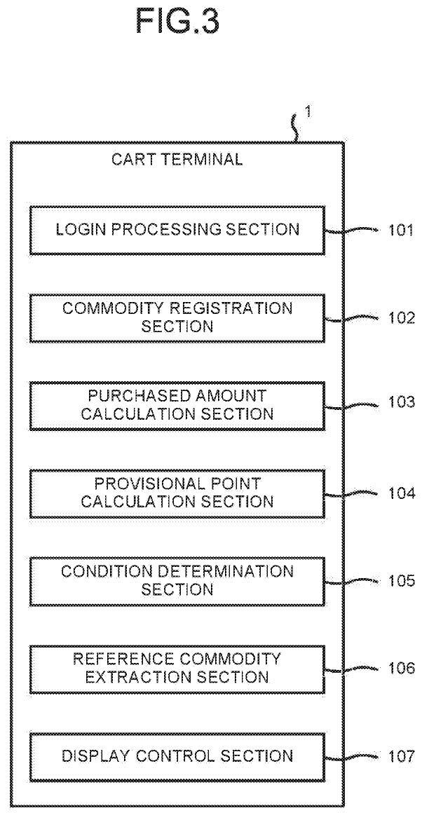

FIG. 3 is a diagram illustrating functional components of the cart terminal 1. As shown in FIG. 3, the cart terminal includes a login processing section 101, a commodity registration section 102, a purchased amount calculation section 103, an estimated point calculation section 104, a condition determination section 105, a reference commodity extraction section 106 and a display control section 107 as functional sections. The functional sections may be realized by a software configuration cooperation with the CPU 14 and a program stored in the non-volatile memory 17 or may be realized as a hardware structure comprising a dedicated circuit or the like.

If the code information read by the reading device 2 is the member code, the login processing section 101 executes processing for specifying a customer according to the member code. For example, the login processing section 101 extracts the point information associated with the member code read by the reading device 2 from the point management file F2 and thus determines that the customer who operates the cart terminal 1 can be specified or identified. The login processing section 101 enables an operation relating to the registration of the commodity, i.e., reading of the commodity code, on condition that the customer is specified. A timing for specifying the customer is not limited to the above example, and the reading of the commodity code may be enabled even if the member code is not yet input.

The commodity registration section 102 is an example of a registration module. If the code information read by the reading device 2 is the commodity code, the commodity registration section 102 registers a commodity specified by the commodity code as a purchase candidate. Specifically, the commodity registration section 102 registers (stores) the commodity code read by the reading device 2 in the commodity registration file F3 to register the commodity as the purchase candidate by the customer. The determination about whether the read code is a commodity code or a member code can be made, for example, based on a difference in coding scheme between the commodity code and the member code.

The purchased amount calculation section 103 calculates the purchased amount by totalizing prices of the commodities registered by the commodity registration section 102. Specifically, the purchased amount calculation section 103 acquires the price associated with each of the commodity codes registered in the commodity registered file F3 from the PLU file F1 and totalizes the acquired prices to obtain the purchased amount. The purchased amount calculation section 103 calculates the purchased amount every time the commodity registration file F3 is updated.

The estimated point calculation section 104 is an example of a calculation module for calculating the value of estimated points. The estimated point calculation section 104 calculates the value of points corresponding to the purchased amount of the commodity registered by the commodity registration section 102 as the value of estimated points. Specifically, the estimated point calculation section 104 calculates the value of points corresponding to the purchased amount calculated by the purchased amount calculation section 103 based on a predetermined granting rule (granting condition) of the regular point as the value of estimated points. The value of estimated points refers to the value of points granted at the time the registered commodity is purchased. The granting rule of the regular point is not particularly limited. For example, the estimated point calculation section 104 may calculate the value of estimated points corresponding to the purchased amount by multiplying the purchased amount by a predetermined granting ratio (for example, 5%) of the regular point.

The condition determination section 105 determines whether or not the purchased amount of the commodity registered by the commodity registration section 102 satisfies the granting condition for the special point. Specifically, the condition determination section 105 determines whether or not the purchased amount calculated by the purchased amount calculation section 103 satisfies the special granting condition stored in the condition setting file F4.

If the condition determination section 105 determines that the purchased amount of the commodity satisfies any one of the special granting conditions, the condition determination section 105 extracts the value of special points associated with the special granting condition as the value of estimated special points. The value of estimated special points becomes the value of special points granted when the registered commodity is purchased. If the condition determination section 105 determines that the purchased amount of the commodity does not satisfy any one of the special granting conditions, the condition determination section 105 calculates a difference between the threshold amount set in the special granting condition and the purchased amount of the commodity.

In a case in which the special granting condition is set stepwise, the condition determination section 105 calculates a difference between the purchased amount of the commodity and a threshold amount closest to the purchased amount among a plurality of the threshold amount higher than the purchased amount of the commodity. Even if the purchased amount of the commodity satisfies a part of the special granting conditions, but there is still a special granting condition that is not satisfied, the condition determination section 105 calculates a difference between the purchased amount of the commodity and a threshold amount closest to the purchased amount among the plurality of the threshold amount set in the special granting conditions that are not satisfied.

The reference commodity extraction section 106 is an example of an extraction module. The reference commodity extraction section 106 extracts, as a reference commodity, a commodity having a price capable of filling the difference based on the difference, between the purchased amount of the commodity and the threshold amount, that is calculated by the condition determination section 105. Specifically, the reference commodity extraction section 106 refers to the price of each commodity registered in the PLU file F1 to extract the commodity code for specifying the commodity the price of which is capable of filling a shortage amount, i.e., the difference between the purchased amount of the commodity and the threshold amount, from the PLU file F1. For example, if the difference between the purchased amount of the commodity and the threshold amount is 300 Yen, the reference commodity extraction section 106 extracts the commodity code for specifying the commodity the price of which (or the sum of prices) exceeds 300 Yen from the PLU file F1 as the reference commodity.

The reference commodity extraction section 106 may extract the reference commodity if the difference between the purchased amount of the commodity and the threshold amount is equal to or less than a predetermined value (for example, 1,000 Yen or less). The value of reference commodities to be extracted is not limited and may be one or more. The reference commodity extraction section 106 may extract a plurality of reference commodities so that the sum of the prices of the commodities fills the shortage amount.

The method of extracting the reference commodity is not limited and any method may be used. For example, the reference commodity extraction section 106 may extract the reference commodity from among a predetermined commodity group, such as a new commodity group, a special commodity group for bargain sale or a key commodity group.

For example, the reference commodity extraction section 106 may narrow down a range for extracting the reference commodity based on a current position (cart position) of the cart terminal 1 in the retail store. Specifically, the reference commodity extraction section 106 narrows down the commodities registered in the PLU file F1 to commodities being sold in the vicinity of the cart position based on the area information of respective commodities registered in the PLU file F1. Then, the reference commodity extraction section 106 selects the reference commodity from the commodities narrowed down.

The method of specifying the cart position is not particularly limited, and a known technology may be used. For example, if a shelf ID of a display shelf is transmitted from a beacon terminal installed in the display shelf in the retail store, the reference commodity extraction section 106 has a function of a position specifying module by cooperating with the near field communication section 19 to acquire (specify) the shelf ID transmitted from the beacon terminal in the vicinity of the cart terminal 1 as a cart position. Then, the reference commodity extraction section 106 extracts a commodity of which the price is capable of filling the shortage amount from commodities (commodity codes) having area information including the shelf ID acquired as the cart position.

The display control section 107 is an example of a display module. The display control section 107 controls a screen displayed on the display device 12. For example, the display control section 107 controls the display device 12 to display a login screen for receiving input of a member code, a commodity registration screen for receiving registration of a commodity or the like.

When the customer is specified by the login processing section 101, the display control section 107 controls the display device 12 to display an accumulated value of points granted to the customer. Specifically, based on the point information read out by the login processing section 101 from the point management file F2, the display control section 107 controls the display device 12 to display the accumulated points total included in the point information.

Further, when the customer is specified by the login processing section 101, the display control section 107 controls the display device 12 to display the accumulated points granted to the customer. Specifically, the display control section 107 controls the display device 12 to display the accumulated points total included in the point information read out by the login processing section 101. Further, the display control section 107 controls the display device 12 to display the number of estimated points calculated by the estimated point calculation section 104.

The display control section 107 controls the display device 12 to display a determination result from the condition determination section 105. Furthermore, the display control section 107 controls the display device 12 to display the reference commodity extracted by the reference commodity extraction section 106 according to the determination result from the condition determination section 105.

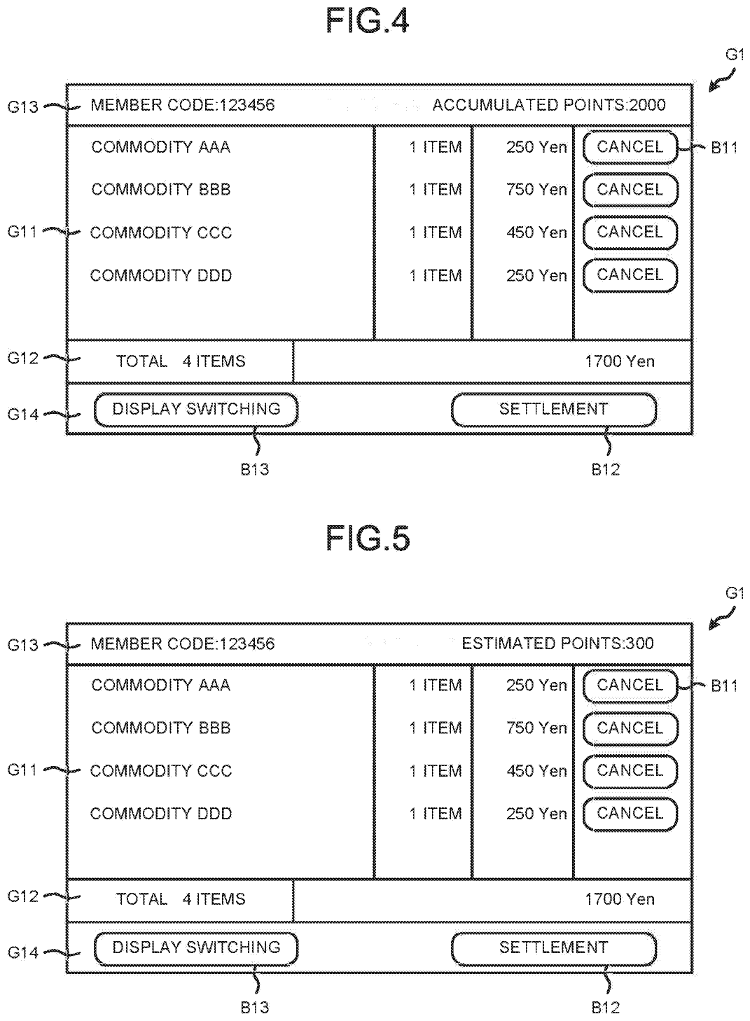

FIG. 4 is a diagram illustrating a commodity registration screen displayed under a control of the display control section 107. As shown in FIG. 4, the commodity registration screen G1 has a commodity display area G11, a total display area G12, a point display area G13 and an operation area G14.

In the commodity display area G11, details of each registered commodity, such as a commodity name, a quantity and a price of the registered commodity, are displayed. Specifically, based on the information stored in the PLU file F1 and the commodity registration file F3, the display control section 107 performs control to display the name, the quantity, the price, etc. of each registered commodity in the commodity display area G11. Cancel buttons B11, respectively corresponding to the commodities displayed in the commodity display area G11, for canceling registration of each of the commodities displayed are displayed. When the cancel button B11 is pressed, the commodity registration section 102 cancels the commodity already registered by deleting the commodity code of the commodity corresponding to the cancel button press from the commodity registration file F3.

The quantity and the purchased amount (total amount) of the registered commodities are shown in the total display area G12. Specifically, based on the calculation result from the purchased amount calculation section 103, the display control section 107 performs control to display a total value of the quantity of commodities stored in the commodity registration file F3 and the purchased amount of the corresponding commodities in the total display area G12.

Information relating to the points of the customer is shown in the point display area G13. Specifically, based on the point information read out by the login processing section 101, the display control section 107 performs control to display the member code of the customer who operates the cart terminal 1 and the value of accumulated points in the point display area G13. Therefore, the customer who operates the cart terminal 1 can easily confirm the current value of points (i.e., the value of accumulated points) granted to him/her by referring to the point display area G13.

Various operation buttons are shown in the operation area G14. Specifically, the display control section 107 performs control to display a settlement button B12 and a display switching button B13 in the operation area G14.

The settlement button B12 is for instructing settlement of the commodities registered in the commodity registration file F3. When the settlement button B12 is pressed, the commodity registration section 102 terminates a registration processing of the commodities, and determines the commodities registered in the commodity registration file F3 relate to one transaction. After pressing the settlement button B12, the customer moves the cart terminal 1 to a checkout apparatus to perform settlement processing for the registered commodities relating to the transaction in the commodity registration file F3.

The display switching button B13 is a toggle operator for switching contents to be shown in the point display area G13. When the display switching button B13 is pressed, the display control section 107 perform control to switch contents to be shown in the point display area G13. Specifically, when the display switching button B13 is pressed when the point display area G13 in FIG. 4 is being shown, the display control section 107 perform control to switch the display in the point display area G13 from the value of accumulated points to the value of estimated points calculated by the estimated point calculation section 104, as shown in FIG. 5.

FIG. 5 is a diagram illustrating a screen (commodity registration screen G1) displayed under a control of the display control section 107. The screen shown in FIG. 5 is substantially the same as that shown in FIG. 4 except for a content shown in the point display area G13. Specifically, in response to the operation on the display switching button B13, the display control section 107 performs control to display the value of estimated points calculated by the estimated point calculation section 104 in the point display area G13. FIG. 5 shows a screen on which 300 points are displayed as the value of estimated points. The customer who operates the cart terminal 1 can easily confirm the value of points (the value of estimated points) to be granted when the registered commodity is purchased by referring to the point display area G13.

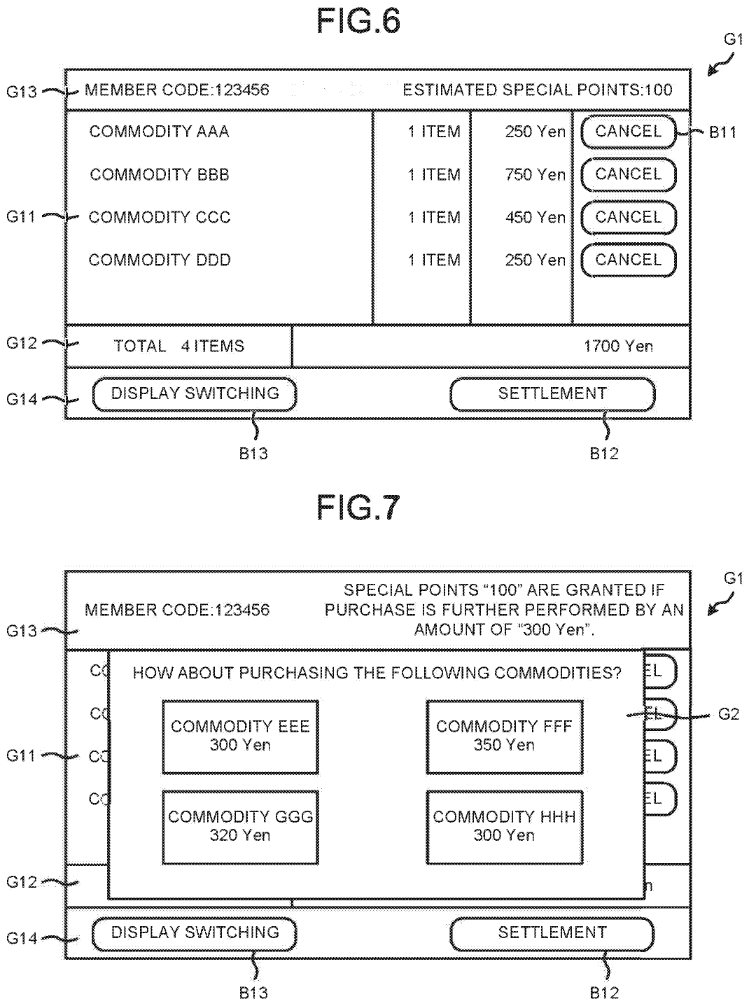

The display control section 107 controls the display device 12 to display the determination result from the condition determination section 105 when the display switching button B13 is pressed again. Specifically, when the display switching button B13 is pressed when the point display area G13 in FIG. 5 is being shown, the display control section 107 switches the display of the display device 12 on which the value of estimated points is shown in the point display area G13 thereon to display the determination result from the condition determination section 105 in the point display area G13, as shown in FIG. 6 and FIG. 7.

FIG. 6 and FIG. 7 are diagrams illustrating a commodity registration screen G1 displayed under a control of the display control section 107. As shown in FIG. 6 and FIG. 7, the display control section 107 performs control to display the determination result from the condition determination section 105 in the point display area G13 in response to the operation on the display switching button B13. FIG. 6 shows a display example in which “100 points” is displayed as the value of estimated special points when the special granting condition is satisfied. In this way, the customer who operates the cart terminal 1 can easily know how many special points (estimated special points) are granted when the registered commodity is purchased by referring to the point display area G13.

On the other hand, FIG. 7 shows a display example when the special granting condition is not satisfied. The display control section 107 performs control to display a shortage amount (300 Yen) which is the difference between the purchased amount of the commodity and the threshold amount and the value of special points (100 points) to be granted if the shortage amount is filled in the point display area G13. The display control section 107 performs control to display a reference commodity screen G2 for recommending the purchase of the reference commodity based on the extraction result from the reference commodity extraction section 106 by superimposing the reference commodity screen G2 on the commodity display area G11 and the total display area G12.

As a result, the customer who uses the cart terminal 1 can easily confirm how much extra amount is required to obtain the value of special points displayed by referring to the point display area G13. The customer who operates the cart terminal 1 can refer to the reference commodity displayed on the reference commodity screen G2 as a reference for determining how much more purchasing is required to meet the condition(s) for granting of the value of special points displayed. In particular, when a reference commodity that is displayed or sold near the position of the cart terminal is extracted and displayed on the reference commodity screen G2, convenience of the customer who wishes to purchase the candidate (reference commodity) can be enhanced. From the viewpoint of the retail store side, by recommending or indicating s reference commodity to the customer via the cart terminal 1, the sales promotion of commodities can be efficiently performed.

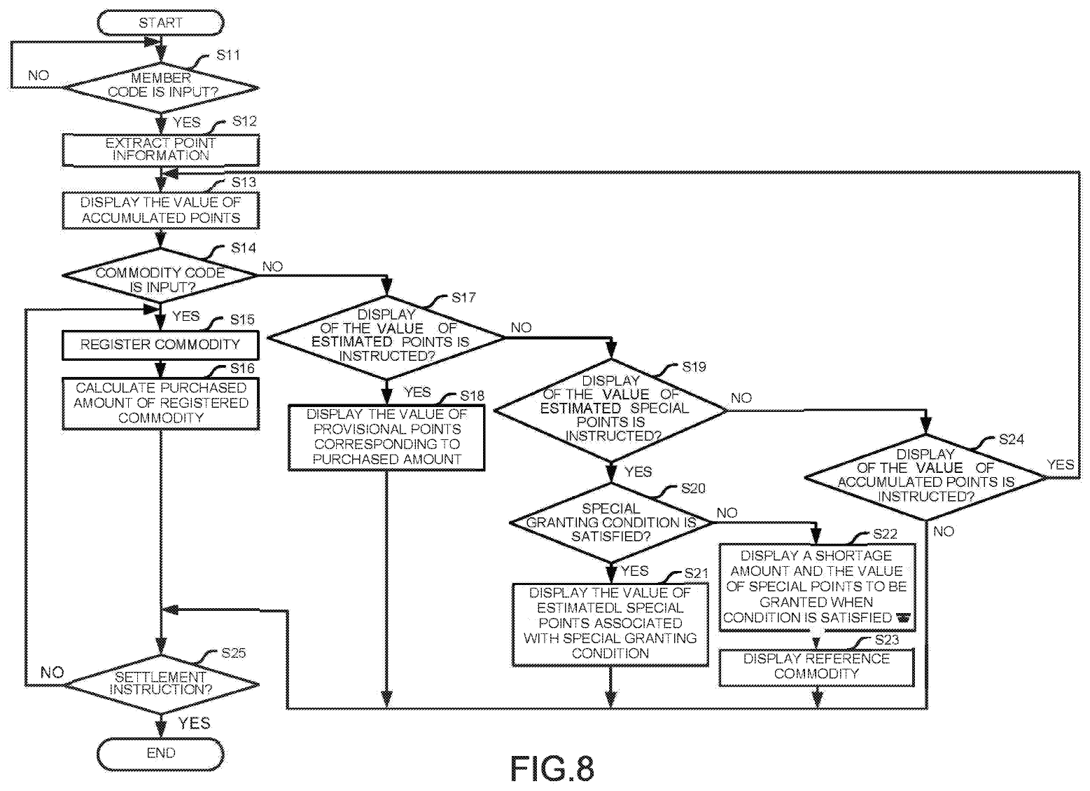

Next, with reference to FIG. 8, operation of the cart terminal 1 is described. FIG. 8 is a flowchart depicting a commodity registration processing executed by the cart terminal 1.

First, the login processing section 101 stands by until the member code is input from the reading device 2 (No in Act S11). If the member code read by the reading device 2 is input (Yes in Act S11), the login processing section 101 reads out the point information associated with the input member code from the point management file F2 (Act S12). Next, the display control section 107 performs control to display the value of accumulated points included in the point information read by the login processing section 101 in the point display area G13 (Act S13).

The commodity registration section 102 determines whether or not a commodity code is input from the reading device 2 (Act S14). If the commodity code is input from the reading device 2 (Yes in Act S14), the commodity registration section 102 stores the input commodity code in the commodity registration file F3 to register the commodity serving as a purchase candidate (Act S15). Then, the purchased amount calculation section 103 calculates the purchased amount of the registered commodity (Act S16), and proceeds to the processing in Act S25. The display control section 107 performs control to display the commodity name, the quantity, the purchased amount, etc. of the commodity in the commodity display area G11 and the total display area G12 each time the commodity is registered.

If no commodity code is input in Act S14 (No in Act S14), the display control section 107 determines whether or not display of the value of estimated points is instructed by an operation on the display switching button B13 displayed in the operation area G14 (Act S17). If it is determined that the display of the value of estimated points is instructed (Yes in Act S17), the display control section 107 performs control to display the value of estimated points calculated by the estimated point calculation section 104 according to the purchased amount in the point display area G13 (Act S18), and then the processing in Act S25 is executed.

The timing at which the estimated point calculation section 104 calculates the value of estimated points is not particularly limited. For example, the estimated point calculation section 104 may calculate the value of estimated points at a timing at which the purchased amount calculation section 103 calculates the purchased amount, or at a timing at which the display of the value of estimated points is instructed.

If no commodity code is input in Act S14 (No in Act S14), the display control section 107 determines whether or not the display of the value of estimated special points is instructed by an operation on the display switching button B13 displayed in the operation area G14 (No in Act S17→Act S19). If it is determined that the display of the value of estimated special points is instructed (Yes in Act S19), the display control section 107 determines whether or not the determination result from the condition determination section 105 indicates that the special granting condition is satisfied (Act S20).

A timing at which the condition determination section 105 determines whether or not the special granting condition is satisfied is not particularly limited. For example, the condition determination section 105 may perform the condition determination at a timing at which the purchased amount calculation section 103 calculates the purchased amount, or at a timing at which the display of the value of estimated special points is instructed.

If the determination result from the condition determination section 105 indicates that the special granting condition is satisfied (Yes in Act S20), the display control section 107 performs control to display the value of estimated special points corresponding to the satisfied special granting condition in the point display area G13 (Act S21), and then the processing in Act S25 is executed.

On the other hand, if the determination result from the condition determination section 105 indicates that the special granting condition is not satisfied (No in Act S20), the display control section 107 performs control to display the shortage amount and the value of special points to be granted if the special granting condition is satisfied in the point display area G13 (Act S22). Next, the display control section 107 performs control to display the reference commodity extracted by the reference commodity extraction section 106 on the reference commodity screen G2 (Act S23), and then the processing in Act S25 is executed.

If the customer who operates the cart terminal 1 intends to designate the reference commodity displayed on the reference commodity screen G2 as the purchase candidate, the customer uses the reading device 2 to read the code symbol attached to the reference commodity. As a result, the reference commodity is registered as the purchase candidate with the cart terminal 1 which executes the processing in Act S14 to Act S16 again.

If no commodity code is input in Act S14 (No in Act S14), the display control section 107 determines whether or not the display of the value of accumulated points is instructed by an operation on the display switching button B13 displayed in the operation area G14 (No in Act S17→No in Act S19→Act S24). If it is determined that the display of the value of accumulated points is instructed (Yes in Act S24), the display control section 107 returns to the processing in Act S13 to perform control to display the value of accumulated points in the point display area G13. If the display of the value of accumulated points is not instructed (No in Act S24), the processing in Act S25 is executed.

In Act S25, the commodity registration section 102 determines whether or not the settlement is instructed by an operation on the settlement button B12 (Act S25). If the settlement is not instructed (No in Act S25), the commodity registration section 102 returns to the processing in Act S14 to continue input of the commodity code. On the other hand, if the settlement is instructed by the operation on the settlement button B12 (Yes in Act S25), the commodity registration section 102 terminates the present processing.

As described above, according to the cart terminal 1 of the present embodiment, the value of accumulated points granted to the customer and the value of estimated points for the commodity designated as the purchase candidate for the customer can be presented to the customer at the time of registering the commodity. In this way, the customer who operates the cart terminal 1 can easily confirm the value of accumulated points granted to him/her and the value of estimated points to be granted if the commodity is purchased, and thus the convenience for use of the point service can be enhanced.

According to the cart terminal 1 of the present embodiment, if the commodity serving as the purchase candidate satisfies the special granting condition for the special point, the value of estimated special points is presented to the customer. In this way, the customer can easily confirm the value of special points to be granted by purchasing the commodity serving as the purchase candidate, and thus also the convenience for use of the point service can be enhanced.

According to the cart terminal 1 of the present embodiment, if the commodity serving as the purchase candidate does not satisfy the special granting condition for the special point, the shortage amount necessary for satisfying the special granting condition is presented to the customer together with the value of special points to be granted if the shortage amount is filled. In this way, the customer can easily confirm the shortage amount necessary for satisfying the special granting condition and the value of special points to be granted when the special granting condition is satisfied, and thus still also the convenience for use of the point service can be enhanced.

In the above embodiment, the cart terminal 1 and the reading device 2 are attached to a main body of a moveable shopping cart 3, and used as the registration apparatus; however, the present disclosure is not limited thereto. In general, various modification, substitutions, and changes to these elements may be made as long as the resulting registration apparatus can be moved within the retail store. For example, the registration apparatus may be attached to a hand-carried shopping basket or the like. Further, the registration apparatus may be a portable device such as a handy (hand-held) terminal or a tablet terminal which can be carried by the customer.

In the above embodiment, the cart terminal 1 holds the PLU file F1, the point management file F2, the commodity registration file F3 and the condition setting file F4; however, the present disclosure is not limited thereto. For example, any one or all of the PLU file F1, the point management file F2, the commodity registration file F3 and the condition setting file F4 may be held in an external device (e.g., a store server, etc.) accessible by the cart terminal 1. In such a case, the cart terminal 1 accesses the appropriate file on the external device through the communication section 18 to perform the registration of the commodity and reading of the value of accumulated points.

In the embodiment described above, the display of the value of accumulated points, the value of estimated points and the value of estimated special points is selectively switched by the operation on the display switching button B13, but the method for displaying each value of points is not limited thereto. For example, the display control section 107 may perform control to display the value of accumulated points, the value of estimated points, and the value of estimated special points on the same screen (that is, simultaneously). Furthermore, for example, the display control section 107 may perform control to display a granting ratio of the regular points (estimated points) as a granting condition together with the value of estimated points. Still for further example, the display control section 107 may perform control to display a special granting condition that is satisfied, a special granting condition that is not satisfied, the value of estimated special points, and the reference commodity based on the determination result from the condition determination section 105.

In the above embodiment, the commodity code is read after the reading of the member code; however, the present disclosure is not limited thereto. For example, the member code may be read after the reading of the commodity code or after the settlement button B12 is pressed. In this case, the display control section 107 performs control to display the value of accumulated points at a timing at which the member code is read.

In the above embodiment, reading of the member code is required; however, in some examples, the reading of the member code may be unnecessary. In this case, the display control section 107 performs control to display the value of estimated points and the value of estimated special points and not to display the value of accumulated points. In the above embodiment, the member code is read by the reading device 2; however, the present disclosure is not limited thereto. For example, in a case in which the member code is stored in a medium such as an IC card, the member code may be read by a device such as an IC card reader. Further, the commodity code is not limited to being read from a code symbol, and the commodity code may instead, or in addition to, be read from an RFID (Radio Frequency Identification) tag attached to a commodity, for example.

The programs executed by the cart terminal 1 of the above embodiment may be incorporated into a storage medium (e.g., non-volatile memory 17) of the cart terminal 1; however, the present disclosure is not limited thereto. The programs may be recorded in a non-volatile, computer-readable recording medium such as a CD-ROM (Compact Disc Read-Only Memory), an FD (Flexible Disk), a CD-R (Compact Disk Recordable), a DVD (Digital Versatile Disk) or the like in an installable or executable file format. Further, the storage medium is not limited to a medium independent from a computer or an embedded system, and may also be a storage medium that stores the programs by downloading the programs transmitted through a LAN or the Internet.

Further, the programs executed by the cart terminal 1 of the above embodiment may be stored in a computer connected to a network such as the Internet and downloaded via the network or may be provided or distributed via a network such as the Internet.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A mobile registration apparatus, comprising:
a code reader configured to read a customer identification code symbol to obtain a customer identifier and to read a commodity identification code symbol to obtain a commodity identifier;
a display; and
a processor configured to:
obtain an accumulated reward points value stored in association with the customer identifier;
perform registration of a commodity identified by the commodity identifier;
calculate estimated reward points based on a total sales price of currently registered commodities; and
control the display to display the accumulated reward points value and the estimated reward points.

2. The mobile registration apparatus according to claim 1, wherein the processor is further configured to:
obtain an extra reward condition for the earning of extra reward points, and
control the display to display the extra reward condition.

3. The mobile registration apparatus according to claim 1, wherein the processor is further configured to:
calculate an additional purchase amount required to satisfy an extra reward condition to earn extra reward points, and
control the display to display the additional purchase amount.

4. The mobile registration apparatus according to claim 3, wherein the processor is further configured to:
extract a candidate commodity, the purchase of which would satisfy the extra reward condition in conjunction with the currently registered commodities, and
control the display to display information of the extracted candidate commodity.

5. The mobile registration apparatus according to claim 4, further comprising:
a wireless communication interface, wherein
the processor is further configured to:
extract a neighboring commodity near a current position of the mobile registration apparatus as the candidate commodity, the current position being determined based on a signal received by the wireless communication interface.

6. The mobile registration apparatus according to claim 5, wherein the signal provides an area identifier for a region of a retail store.

7. The mobile registration apparatus according to claim 6, wherein the signal is a beacon signal from a beacon terminal.

8. The mobile registration apparatus according to claim 4, wherein the processor controls the display to display the additional purchase amount and the information of the candidate commodity on a same screen.

9. The mobile registration apparatus according to claim 8, wherein the processor controls the display to:
display the accumulated reward points value on a first screen,
display the estimated reward points on a second screen directly accessible from the first screen, and
display the additional purchase amount and the information of the candidate commodity on a third screen directly accessible from at least one of the first and second screens.

10. The mobile registration apparatus according to claim 1, further comprising:
a storage device in which the accumulated reward points value is stored in association with the customer identifier, wherein
the processor obtains the accumulated reward points value from the storage device.

11. The mobile registration apparatus according to claim 1, further comprising:
a wireless communication interface, wherein
the processor obtains the accumulated reward points value from an external server via the wireless communication interface.

12. The mobile registration apparatus according to claim 1, further comprising:
a shopping cart, wherein
the code reader and the display are attached to the shopping cart.

13. A shopping cart, comprising:
a main body; and
a mobile registration apparatus mounted on the main body, the mobile registration apparatus comprising:
a code reader configured to read a customer identification code symbol to obtain a customer identifier and to read a commodity identification code symbol to obtain a commodity identifier;
a display; and
a processor configured to:
obtain an accumulated reward points value stored in association with the customer identifier;
perform registration of a commodity identified by the commodity identifier;
calculate estimated reward points based on a total sales price of currently registered commodities; and
control the display to display the accumulated reward points value and the estimated reward points.

14. The shopping cart according to claim 13, wherein the processor is further configured to:
obtain an extra reward condition for the earning of extra reward points, and
control the display to display the extra reward condition.

15. The shopping cart according to claim 14, wherein the processor is further configured to:
extract a candidate commodity, the purchase of which would satisfy the extra reward condition in conjunction with the currently registered commodities, and
control the display to display information of the extracted candidate commodity.

16. The shopping cart according to claim 15, wherein
the mobile registration apparatus further comprises a wireless communication interface, and
the processor is further configured to:
extract a neighboring commodity near a current position of the mobile registration apparatus as the candidate commodity, the current position being determined based on a signal received by the wireless communication interface.

17. A commodity registration method, comprising:
reading a customer identification code symbol to obtain a customer identifier;
obtaining an accumulated reward points value stored in association with the customer identifier;
displaying the accumulated reward points value on a display mounted to a shopping cart;
reading a commodity identification code symbol of a commodity to obtain a commodity identifier for the commodity;
performing registration of the commodity identified by the commodity identifier;
calculating estimated reward points based on a total sales price of currently registered commodities; and
displaying the estimated reward points on the display mounted to the shopping cart.

18. The commodity registration method according to claim 17, further comprising:
obtaining an extra reward condition for the earning of extra reward points, and
displaying the extra reward condition on the display mounted on the shopping cart.

19. The commodity registration method according to claim 18, further comprising:
extracting a candidate commodity, the purchase of which would satisfy the extra reward condition in conjunction with the currently registered commodities, and
displaying commodity information of the extracted candidate commodity.

20. The commodity registration method according to claim 19, further comprising:
extracting a neighboring commodity near a current position of the shopping cart as the candidate commodity.
